(19) United States
(12) Patent Application Publication
(10) Pub. No.: US 2021/0124870 A1
(43) Pub. Date: Apr. 29, 2021

(54) EXTRACTION METHOD, EXTRACTION DEVICE, AND EXTRACTION PROGRAM

(71) Applicant: NIPPON TELEGRAPH AND TELEPHONE CORPORATION, Tokyo (JP)

(72) Inventors: Mayo YAMASAKI, Musashino-shi, Tokyo (JP); Hideki KAWABE, Musashino-shi, Tokyo (JP)

(73) Assignee: NIPPON TELEGRAPH AND TELEPHONE CORPORATION, Tokyo (JP)

(21) Appl. No.: 17/257,023

(22) PCT Filed: Jul. 4, 2019
(86) PCT No.: PCT/JP2019/026736

§ 371 Date: Dec. 30, 2020

(30) Foreign Application Priority Data
Jul. 5, 2018 (JP) 2018-128341

(51) Int. Cl. G06F 40/143; G06F 40/166

(52) U.S. Cl. CPC G06F 40/143; G06F 40/166

(57) ABSTRACT

A paragraph divider (15a) divides text to which markup information representing vertices of a graph structure has been assigned into paragraphs, a vertex extractor (15b) extracts vertices for each paragraph, and an edge extractor (15c) extracts an edge between the extracted vertices for each paragraph. A storage unit (14) may store a schema (14a) for specifying edges between attributes of vertices of a graph structure, the paragraph divider (15a) may divide text to which markup information representing vertices of a graph structure and attributes of the vertices has been assigned into paragraphs, the vertex extractor (15b) may extract the vertices and the attributes of the vertices for each paragraph, and the side extractor (15c) may extract edges specified in the schema (14a) for each paragraph. A vertex combiner (15d) may combine vertices redundantly extracted between paragraphs.

### TECHNICAL FIELD

The present invention relates to an extraction method, an extraction apparatus, and an extraction program.

### BACKGROUND ART

In recent years, the necessity of sharing information has been widely recognized in information security communities. Accordingly, for information sharing, a structured format which allows reusable representation of a graph structure composed of a group of vertices and a group of edges representing the connection relationship between the vertices has been proposed. Meanwhile, information sharing is performed in a text format in many cases.

Conventionally, a device which receives a graph structure as an input and performs processing such as analysis and display is known. For example, a device called Graphviz which receives proprietary domain-specific language (DSL) called DOT language as an input is known (refer to NPL 1). Furthermore, a device which receives graph exchange language (GXL) using an extensible markup language (XML) as an input (refer to NPL 2), a device which receives GraphML as an input (refer to NPL 3), and the like are known. In such devices, graph structures written in independent manners are received as inputs instead of a natural language.

Moreover, a device which receives a simple graph structure described in formats such as MarkDown and reStructuredText which can provide a simple graph structure to text as an input is known (refer to NPL 4).

### CITATION LIST

### Non Patent Literature

[NPL 1] John Ellson, Emden R. Gansner, Eleftherios Koutsofios, Stephen C. North, Gordon Woodhull, “Graphviz and Dynagraph—Static and Dynamic Graph Drawing Tools,” In Graph drawing software, Springer, 2004, p., 127-148
[NPL 2] Richard C. Holt, Andreas Winter, Andy Schurr, “Gxl: Toward a Standard Exchange Format,” In Reverse Engineering, Seventh Working Conference, IEEE, 2000, p. 162-171
[NPL 3] Ulrik Brandes, Markus Eiglsperger, Ivan Herman, Michael Himsolt, M. Scott Marshall, “GraphML Progress Report Structural Layer Proposal,” In International Symposium on Graph Drawing, Springer, 2001 p. 501-512
[NPL 4] John Gruber, Aaron Swartz, et al., “Markdown,” [online], 2004, [retrieved May 18, 2018], Internet <URL:https://daringfireball.net/projects/markdown/>

### SUMMARY OF THE INVENTION

### Technical Problem

However, in conventional techniques, it is difficult to simultaneously receive text and a graph structure included in the text as an input and process the input. That is, in conventional techniques, it is difficult to describe markup information in a complicated graph structure in text. Accordingly, when certain text and a graph structure representing knowledge and the like that can be extracted from the text are processed, it is necessary to separately input the text and markup information of the graph structure separately extracted from the text.

Accordingly, costs for the manpower necessary to extract a graph structure having high reusability with respect to devices from the text separately or update the graph structure according to changes in the text are high. Consequently, information with a graph structure with high reusability becoming widespread has been hampered.

An object of the present invention devised in view of the aforementioned circumstances is to simultaneously receive text and a graph structure included in the text as an input and process the input.

### Means for Solving the Problem

To solve the aforementioned problem and accomplish the object, an extraction method according to the present invention is an extraction method performed by an extraction apparatus, including: a paragraph dividing step of dividing text to which markup information representing vertices of a graph structure has been assigned into paragraphs; a vertex extraction step of extracting vertices and attributes of the vertices for each paragraph; and an edge extraction step of extracting an edge between the extracted vertices for each paragraph.

### Effects of the Invention

According to the present invention, it is possible to simultaneously receive text and a graph structure included in the text as an input and process the input.

### BRIEF DESCRIPTION OF DRAWINGS

FIG. 1 is a schematic diagram exemplifying an overview configuration of an extraction apparatus.

FIG. 2 is an explanatory diagram for describing processing of a vertex extractor.

FIG. 3 is an explanatory diagram for describing processing of an edge extractor.

FIG. 4 is an explanatory diagram for describing processing of the extraction apparatus.

FIG. 5 is a flowchart showing an extraction processing procedure.

FIG. 6 is an explanatory diagram for describing effects of extraction processing.

FIG. 7 is a diagram showing an example of a computer executing an extraction program.

### DESCRIPTION OF EMBODIMENTS

Hereinafter, an embodiment of the present invention will be described in detail with reference to the drawings. Meanwhile, the present invention is not limited to this embodiment. Further, elements which are the same are designated by the same reference numerals in the drawings.

[Configuration of Extraction Apparatus]

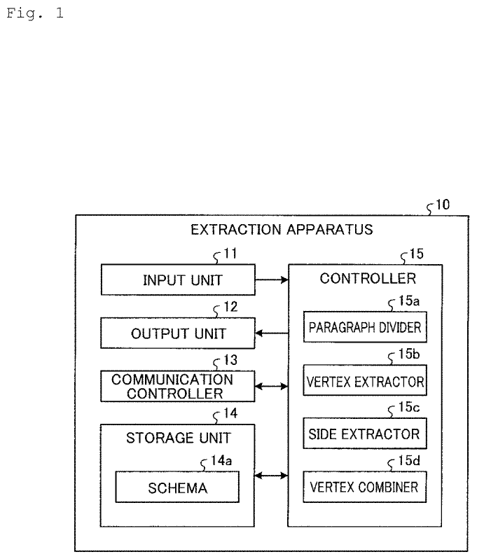

FIG. 1 is a schematic diagram exemplifying an overview configuration of an extraction apparatus. As shown in FIG. 1, an extraction apparatus 10 is realized by a general-purpose computer such as a personal computer and includes an input unit 11, an output unit 12, a communication controller 13, a storage unit 14, and a controller 15.

The input unit 11 is realized using an input device such as a keyboard or a mouse and receives various types of instruction information such as processing initiation for the controller 15 in response to an input operation performed by an operator. The output unit 12 is realized by a display device such as a liquid crystal display, a printing device such as a printer, or the like.

The communication controller 13 is realized by a network interface card (NIC) or the like and controls communication between an external device and the controller 15 via an electric communication line such as a local area network (LAN) or the Internet.

The storage unit 14 is realized by a semiconductor memory element such as a random access memory (RAM) or a flash memory, or a storage device such as a hard disk or an optical disc and stores parameters of a data generation model trained through extraction processing which will be described later, and the like. Meanwhile, the storage unit 14 may be configured to communicate with the controller 15 through the communication controller 13. In the present embodiment, schema 14a is stored in the storage unit 14.

Here, the schema 14a is information that specifies an edge between attributes of vertices of a graph structure and corresponds to a model of a graph structure. For example, in the schema 14a, an edge in a direction from a vertex of an attribute “sub” to a vertex of an attribute “super” is specified as an edge “is-a”.

The controller 15 is realized using a central processing unit (CPU) or the like and executes a processing program stored in a memory. Accordingly, the controller 15 serves as a paragraph divider 15a, a vertex extractor 15b, an edge extractor 15c, and a vertex combiner 15d, as illustrated in FIG. 1. Meanwhile, these functional units may be respectively mounted in different pieces of hardware or some thereof may be mounted in different pieces of hardware.

The paragraph divider 15a divides text to which markup information representing vertices of a graph structure has been assigned into paragraphs. Specifically, the paragraph divider 15a receives input of text to which markup information representing vertices of a graph structure and attributes of the vertices has been assigned and divides the text into paragraphs.

The vertex extractor 15b extracts a vertex for each paragraph. Specifically, the vertex extractor extracts a vertex and an attribute of the vertex for each paragraph.

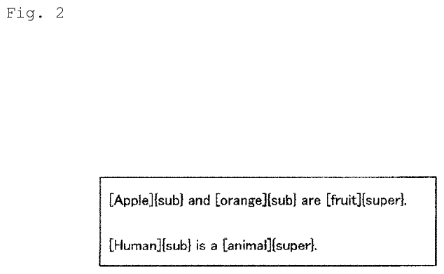

Here, FIG. 2 is an explanatory diagram for describing processing of the vertex extractor 15b. As illustrated in FIG. 2, markup information represented in a format of [vertex name]{vertex attribute}, for example, is assigned to input text as information representing vertices of a graph structure and attributes of the vertices. For example, text illustrated in FIG. 2 includes markup information representing a vertex having a vertex name “Apple” and an attribute “sub”.

The vertex extractor 15b extracts, from a first sentence of the text illustrated in FIG. 2, a vertex having a vertex name “apple” and a vertex attribute “sub,” a vertex having a vertex name “orange” and a vertex attribute “sub,” and a vertex having a vertex name “fruit” and a vertex attribute “super.” Further, the vertex extractor 15b extracts, from a second sentence of the text illustrated in FIG. 2, a vertex having a vertex name “human” and a vertex attribute “sub” and a vertex having a vertex name “animal” and a vertex attribute “super”.

The side extractor 15c extracts an edge between extracted vertices for each paragraph. Specifically, the side extractor 15c extracts an edge specified in the schema 14a for each paragraph.

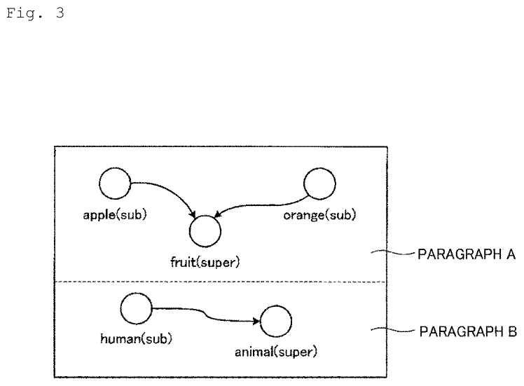

Here, FIG. 3 is an explanatory diagram for describing processing of the side extractor 15c. As shown in FIG. 3, the side extractor 15c extracts, from a paragraph A of text, an edge “is-a” in a direction from a vertex having an attribute “sub” and a vertex name “apple” to a vertex having an attribute “super” and a vertex name “fruit,” for example. In addition, the side extractor 15c extracts, from the paragraph A of the text, an edge “is-a” in a direction from a vertex having an attribute “sub” and a vertex name “orange” to the vertex having the attribute “super” and the vertex name “fruit.” In this manner, a graph structure composed of three vertices and two edges is extracted from the paragraph A of the text.

In the same manner, the side extractor 15c extracts, from a paragraph B of the text, an edge “is-a” in a direction from a vertex having an attribute “sub” and a vertex name “human” to a vertex having an attribute “super” and a vertex name “animal.” In this manner, a graph structure composed of two vertices and one side is extracted from the paragraph B of the text.

Since the schema 14a with a low change frequency is stored in the storage unit 14 in advance, as described above, the side extractor 15c can extract edges from text including the same graph structure with high efficiency with reference to the same schema 14a.

Meanwhile, when the schema 14a is not stored in the storage unit 14, the side extractor 15c may extract edges between all vertices on the assumption that edges are extended between all extracted vertices for each paragraph. Accordingly, it is possible to omit description of edges.

Referring back to FIG. 1, the vertex combiner 15d combines vertices redundantly extracted between paragraphs. For example, when vertices of the paragraph A and vertices of the paragraph B shown in FIG. 3 include vertices having the same vertex name and the same vertex attribute, the vertex combiner 15d combines the graph structure of the paragraph A and the graph structure of the paragraph B using these vertices. Accordingly, the extraction apparatus 10 can extract a graph structure with higher reusability from text.

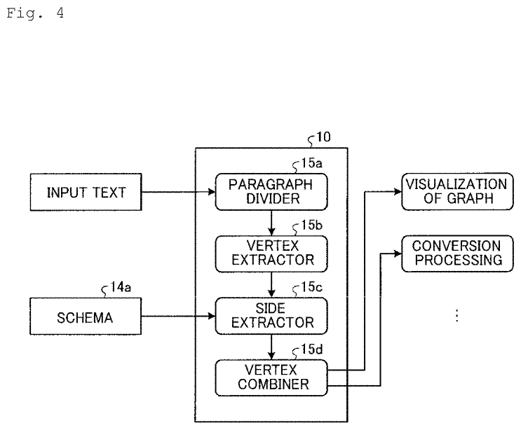

FIG. 4 is an explanatory diagram for describing processing of the extraction apparatus 10. As shown in FIG. 4, the extraction apparatus 10 receives input of text to which information representing vertices of a graph structure and attributes of the vertices has been assigned. The paragraph divider 15a divides the input text into paragraphs. The vertex extractor 15b extracts vertices and vertex attributes from the paragraphs.

In addition, the extraction apparatus 10 receives input of the schema 14a that is a model of a graph structure and stores the schema 14a in the storage unit 14. The side extractor 15c extracts edges specified in the schema 14a from the relationship between the extracted vertices with reference to the schema 14a. In addition, the vertex combiner 15d combines vertices redundantly extracted between paragraphs.

The extraction apparatus 10 performs processing such as visualization of a graph, conversion into other data formats, and the like using a graph structure extracted as described above. In this manner, the extraction apparatus 10 can receive input of text including a graph structure, extract the graph structure and execute processing on the text and the extracted graph structure.

[Extraction Processing]

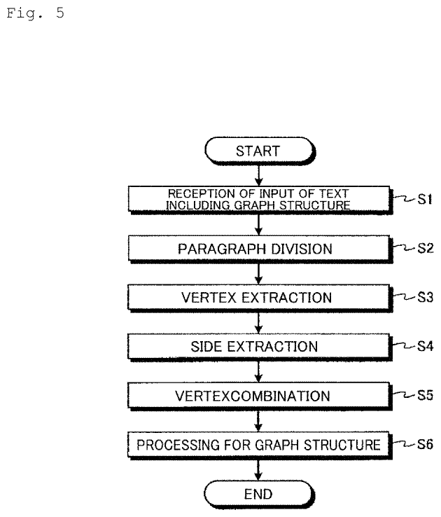

Next, extraction processing performed by the extraction apparatus 10 according to the present embodiment will be described with reference to FIG. 5. FIG. 5 is a flowchart showing an extraction processing procedure. The flowchart of FIG. 5 starts, for example, at a timing at which a user inputs an operation of instructing start of extraction processing.

First, the paragraph divider 15a receives input of text including graph structures that are processing objects (step S1). Then, the paragraph divider 15a divides the input text into paragraphs (step S2).

Next, the vertex extractor 15b extracts vertices and vertex attributes for each paragraph (step S3). In addition, the side extractor 15c extracts an edge specified in the schema 14a from the relationship between the extracted vertices for each paragraph (step S4). Accordingly, graph structures are extracted from the text.

Further, if there are vertices redundantly extracted between paragraphs, the vertex combiner 15d combines the graph structures through the vertices (step S5). The controller 15 executes processing for the graph structures, such as visualization of graphs and data format conversion processing, using the graph structures extracted from the text as described above (step S6). Further, the controller 15 executes processing on the text from which the graph structures have been extracted. Accordingly, a series of extraction processes ends.

As described above, in the extraction apparatus 10 of the present embodiment, the paragraph divider 15a divides text to which markup information representing vertices of a graph structure has been assigned into paragraphs. In addition, the vertex extractor 15b extracts vertices for each paragraph. Further, the side extractor 15c extracts an edge between extracted vertices for each paragraph.

Accordingly, it is possible to extract a graph structure included in text using a lightweight markup information that represents vertices of the graph structure even when edges are not described in a complicated manner. In this manner, text and a graph structure included in the text can be simultaneously received as an input and processed.

In addition, the storage unit 14 may store the schema 14a that specifies an edge between attributes of vertices of a graph structure. In such a case, the paragraph divider 15a divides text to which markup information representing vertices of a graph structure and attributes of the vertices has been assigned into paragraphs. Then, the vertex extractor 15b extracts a vertex and an attribute of the vertex for each paragraph. In addition, the side extractor 15c extracts an edge specified in the schema 14a for each paragraph. Accordingly, the extraction apparatus 10 can extract edges of a graph structure with high efficiency using the schema 14a that is a model of a graph structure with a low change frequency even when complicated edges are not described in text.

Furthermore, the vertex combiner 15d combines vertices redundantly extracted between paragraphs. Accordingly, it is possible to extract a larger-scale graph structure from text.

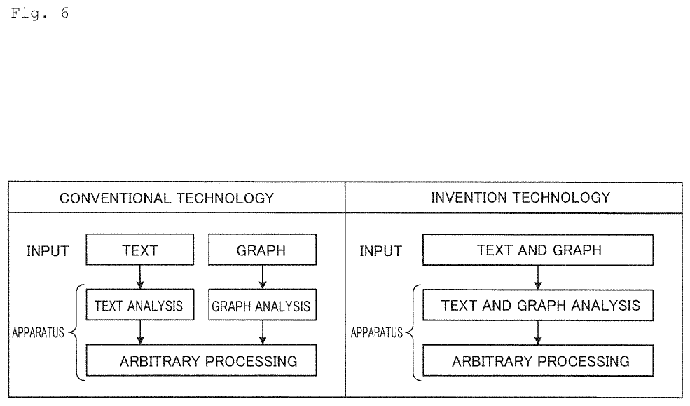

Here, FIG. 6 is an explanatory diagram for describing effects of extraction processing. As shown in FIG. 6, when arbitrary conventional processing is performed by analyzing text and a graph structure included in the text, the text and markup information of the graph structure extracted from the text need to be separately input to an apparatus and processed.

In contrast, in extraction processing performed by the extraction apparatus 10 of the present embodiment, even when text in which markup information of a graph structure is described is input as it is, arbitrary processing can be performed on the text and the graph structure. Accordingly, it is possible to reduce the costs for manpower such as generation costs for separately extracting a graph structure from the text and describing the graph structure, and maintenance costs for training for generation, updating of re-extracting a graph structure when text is changed, and the like.

Accordingly, it is possible to describe structuralized information having high reusability as text in a lightweight format and share the information with high efficiency. In addition, a corresponding relation between text and a graph structure is visually easily ascertained and thus generation of discrepancies in meaning is curbed. Accordingly, it is possible to promote sharing of various types of information and knowledge which can be described as graph structures.

[Program]

It is also possible to create a program in which processing executed by the extraction apparatus 10 according to the above-described embodiment is described in a computer-executable language. As an embodiment, the extraction apparatus 10 may be implemented by installing an extraction program executing the aforementioned extraction processing in a desired computer as package software or online software. For example, it is possible to cause an information processing apparatus to serve as the extraction apparatus 10 by the extraction program being executed by the information processing apparatus. Here, the information processing apparatus includes a desktop or laptop personal computer. In addition, the information processing apparatus includes mobile communication terminals such as a smartphone, a cellular phone, and a personal handyphone system (PHS), and further includes slate terminals such as a personal digital assistant (PDA), and the like in the category.

Further, the extraction apparatus 10 may be implemented as a server apparatus which has a terminal device used by a user as a client and provides a service with respect to the aforementioned extraction processing to the client. For example, the extraction apparatus 10 may be implemented as a server apparatus which receives text to which information representing a graph structure has been assigned as an input and provides an extraction processing service for outputting processing results with respect to the text and the graph structure. In this case, the extraction apparatus 10 may be implemented as a web server or implemented as a cloud which provides a service with respect to the aforementioned extraction processing according to outsourcing. An example of a computer which executes an extraction program for realizing the same function as that of the extraction apparatus 10 will be described below.

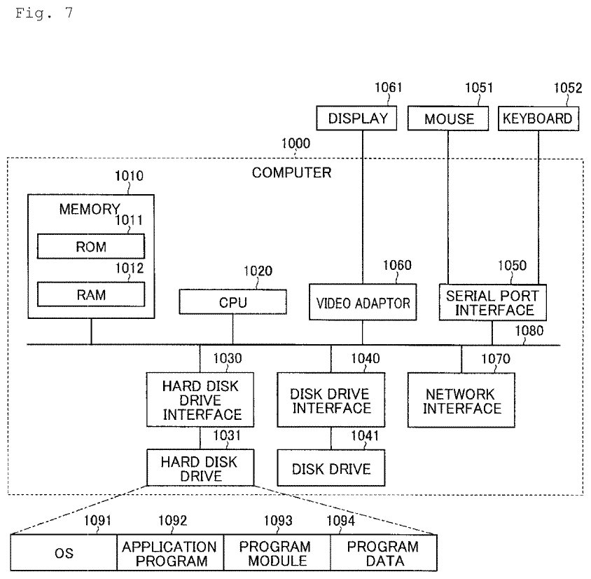

FIG. 7 is a diagram showing an example of a computer executing the extraction program. A computer 1000 includes, for example, a memory 1010, a CPU 1020, a hard disk drive interface 1030, a disk drive interface 1040, a serial port interface 1050, a video adaptor 1060, and a network interface 1070. These components are connected through a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1031. The disk drive interface 1040 is connected to a disc drive 1041. For example, detachable storage media such as a magnetic disk and an optical disc are inserted into the disc drive 1041. For example, a mouse 1051 and a keyboard 1052 are connected to the serial port interface 1050. For example, a display 1061 is connected to the video adaptor 1060.

Here, the hard disk drive 1031 stores, for example, an OS 1091, an application program 1092, a program module 1093, and program data 1094. The information described in the aforementioned embodiment is stored in the hard disk drive 1031 and the memory 1010, for example.

In addition, the extraction program is stored in the hard disk drive 1031, for example, as the program module 1093 in which instructions executed by the computer 1000 is described. Specifically, the program module 1093 in which each piece of processing executed by the extraction apparatus 10 described in the aforementioned embodiment is described is stored in the hard disk drive 1031.

Further, data used for information processing using the extraction program is stored in the hard disk drive 1031 as the program data 1094, for example. In addition, the CPU 1020 reads the program module 1093 or the program data 1094 stored in the hard disk drive 1031 to the RAM 1012 as necessary and executes the aforementioned procedures.

Meanwhile, the present invention is not limited to a case in which the program module 1093 and the program data 1094 with respect to the extraction program are stored in the hard disk drive 1031, and the program module 1093 and the program data 1094 may be stored in a detachable storage medium and read by the CPU 1020 through the disc drive 1041 or the like, for example. Alternatively, the program module 1093 and the program data 1094 with respect to the extraction program may be stored in another computer connected via a network such as a LAN or a wide area network (WAN) and read by the CPU 1020 through the network interface 1070.

Although an embodiment to which the invention according to the inventor is applied has been described above, the present invention is not limited by description and drawings constituting a part of the disclosure of the present invention according to the present embodiment. That is, all of other embodiments, examples, operation technology, and the like implemented by those skilled in the art on the basis of the present embodiment are included in the scope of the present invention.

### REFERENCE SIGNS LIST

10 Extraction apparatus
11 Input unit
12 Output unit
13 Communication controller
14 Storage unit
14a Schema
15 Controller
15a Paragraph divider
15b Vertex extractor
15c Side extractor
15d Vertex combiner

1. An extraction method performed by an extraction apparatus, comprising:
a paragraph dividing step of dividing text to which markup information representing vertices of a graph structure has been assigned into paragraphs;
a vertex extraction step of extracting vertices for each paragraph; and
an edge extraction step of extracting an edge between the extracted vertices for each paragraph.

2. The extraction method according to claim 1,
wherein the extraction apparatus includes a memory which stores a schema for specifying edges between attributes of vertices of a graph structure, and
wherein text to which markup information representing vertices of a graph structure and attributes of the vertices has been assigned is divided into paragraphs in the paragraph dividing step, the vertices and the attributes of the vertices are extracted for each paragraph in the vertex extraction step, and the edges specified in the schema are extracted for each paragraph in the side extraction step.

3. The extraction method according to claim 1, further comprising a vertex combining step of combining the vertices redundantly extracted between the paragraphs.

4. An extraction apparatus comprising:
paragraph divider circuitry configured to divided text to which markup information representing vertices of a graph structure has been assigned into paragraphs;
vertex circuitry configured to extract the vertices for each paragraph; and
edge extractor circuitry configured to extract an edge between the extracted vertices for each paragraph.

5. A non-transitory computer readable medium including a computer program for causing a computer to execute:
a paragraph dividing step of dividing text to which markup information representing vertices of a graph structure has been assigned into paragraphs;
a vertex extraction step of extracting the vertices for each paragraph; and
an edge extraction step of extracting an edge between the extracted vertices for each paragraph.
